(19) United States
(12) Patent Application Publication
(10) Pub. No.: US 2015/0002536 A1
(43) Pub. Date: Jan. 1, 2015

(54) LABEL RENDERING FOR COMPUTERIZED MOBILE DEVICE WITH HEADING SENSITIVE MAP DISPLAY

(71) Applicant: Charles Mendis, Mountain View, CA (US)

(72) Inventor: Charles Mendis, Mountain View, CA (US)

(73) Assignee: GOOGLE INC., Mountain View, CA (US)

(21) Appl. No.: 13/244,731

(22) Filed: Sep. 26, 2011

Related U.S. Application Data
(63) Continuation of application No. 13/218,440, filed on Aug. 25, 2011, now abandoned.

(51) Int. Cl. G09G 5/00

(52) U.S. Cl. 345/619

(57) ABSTRACT

A method for displaying labels on a map image on a computerized mobile device includes displaying a map image and at least one label in a first orientation on a display unit, the at least one label associated with at least one feature on the map image and disposed at a first location. The method also includes changing the map image to a second orientation different from the first orientation and displacing the at least one label from the first location to a second location to maintain the association between the label and the feature. The method further includes displaying the map image in the second orientation on the display unit, and displaying the at least one label in the first orientation and disposed at the second location. A device programmed to carry out the method is also provided.

### RELATED APPLICATION

This application is a continuation of and claims priority to U.S. patent application Ser. No. 13/218,440 entitled “Label Rendering for Computerized Mobile Device with Heading Sensitive Map Display” filed on Aug. 25, 2011, the entire disclosure of which is hereby expressly incorporated by reference herein.

### FIELD OF TECHNOLOGY

This patent is directed to a method for displaying map labels on a computerized mobile device having a heading-sensitive map display and the computerized mobile device so programmed, and in particular a method for displaying heading-insensitive map labels for a computerized mobile device having a heading-sensitive map display and the computerized mobile device so programmed.

### BACKGROUND

Conventional mobile devices, such as mobile phones, smart phones and the like, typically include an onboard compass. The compass may be used to determine the compass heading that the user is facing by holding the mobile device aligned in the direction the user is facing. Moreover, the compass heading may be used to determine the orientation of maps and map information displayed by the mobile device.

That is to say, in some mobile devices, the maps and map information may be fixed in a particular orientation relative to the viewer. As such, even though the device may display the location of the mobile device user relative to the map display, the orientation of the mobile device may differ dramatically from the orientation of the map display. As a consequence, the user may experience a sense of disorientation when attempting to use the map display as a navigational device.

Consequently, some mobile devices permit the user to have the map and map information reorient themselves in keeping with changes in the orientation of the mobile device. However, while the devices may permit the map and map information to change orientation, and thereby provide a less disorienting experience for the user, the relative orientation between the map and the map information is generally fixed.

Considering for a moment a map having a grid-like network of streets oriented at right angles to each other, information regarding streets running horizontally may be displayed so as to be read easily by the viewer without having to turn his or her head to the side. On the other hand, information regarding streets running vertically may be displayed so that the viewer can only read it upright if the viewer angles their head to the side. If however, the orientation of the mobile device is changed in a response to a change in the compass heading of the mobile device, the map and the map information changes its orientation, such that street information previously readable may be difficult to read unless read from the side, and street information previously read only from the side may be readable now.

As set forth in greater detail below, the present disclosure sets forth an improved assembly embodying advantageous alternatives to the conventional devices and methods discussed above. In particular, the present disclosure addresses the significant unmet need in providing universally readable map labels for a computerized mobile device that permits changes in orientation of the map in response to changes in orientation of the mobile device.

### SUMMARY

According to an aspect of the present disclosure, a method for displaying labels on a map image on a computerized mobile device includes displaying a map image in a first orientation on a display unit of a computerized mobile device, the map image comprising at least one feature, and displaying at least one label in a first orientation on the display unit with the map image in the first orientation, the at least one label associated with the at least one feature and disposed at a first location on the display unit. The method also includes changing the map image to a second orientation different from the first orientation using a processor of the computerized mobile device, and displacing the at least one label from the first location to a second location as the map image is changed to the second orientation to maintain the association between the at least one label and the at least one feature using the processor. The map further includes displaying the map image in the second orientation on the display unit, and displaying the at least one label in the first orientation with the map image in the second orientation, the at least one label disposed at the second location on the display unit.

According to another aspect of the present disclosure, a computerized mobile device includes a display unit and a processor coupled to the display unit. The processor is programmed to control the display unit to display a map image in a first orientation on a display unit of a computerized mobile device, the map image comprising at least one feature, and to control the display unit to display at least one label in a first orientation on the display unit with the map image in the first orientation, the at least one label associated with the at least one feature and disposed at a first location on the display unit. The processor is also programmed to change the map image to a second orientation different from the first orientation, and to displace the at least one label from the first location to a second location as the map image is changed to the second orientation to maintain the association between the at least one label and the at least one feature. Further, the processor is programmed to control the display unit to display the map image in the second orientation on the display unit, and to control the display unit to display the at least one label in the first orientation with the map image in the second orientation, the at least one label disposed at the second location on the display unit.

According to a further aspect of the present disclosure, a tangible non-transitory computer-readable medium is provided having computer executable instructions stored thereon that, when executed by one or more processors of a computerized mobile device, cause the one or more processors to control a display unit to display a map image in a first orientation on a display unit of a computerized mobile device, the map image comprising at least one feature, and to control a display unit to display at least one label in a first orientation on the display unit with the map image in the first orientation, the at least one label associated with the at least one feature and disposed at a first location on the display unit. The instructions may also cause the one or more processors to change the map image to a second orientation different from the first orientation, and to displace the at least one label from the first location to a second location as the map image is changed to the second orientation to maintain the association between the at least one label and the at least one feature. Further, the instructions may cause the one or more processors to control a display unit to display the map image in the second orientation on the display unit, and to control a display unit to display the at least one label in the first orientation with the map image in the second orientation, the at least one label disposed at the second location on the display unit.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a schematic of an exemplary computerized mobile device that may be used with a computer implemented method for label rendering for use with a heading-sensitive map display according to the present disclosure;

FIG. 2 is an illustration of screenshot of a display unit controlled to display a map image in a first orientation and map labels in a first orientation;

FIG. 3 is an illustration of screenshot of a display unit controlled to display the map image of FIG. 2 in a second orientation and the map labels of FIG. 2 in the same orientation as in FIG. 2;

FIG. 4 is an illustration of screenshot of a display unit controlled to display the map image of FIG. 2 in a first of a series of intermediate orientations between the first and second orientations and the map labels of FIG. 1 in the same orientation as in FIG. 2;

FIG. 5 is an illustration of screenshot of a display unit controlled to display the map image of FIG. 2 in a second of a series of intermediate orientations between the first and second orientations and the map labels of FIG. 1 in the same orientation as in FIG. 2;

FIG. 6 is a flowchart of an exemplary computer-implemented method for displaying a map image and associated map labels according to the present disclosure; and

FIG. 7 is a flowchart of another exemplary computer-implemented method for displaying a map image and associated map labels according to the present disclosure.

### DETAILED DESCRIPTION

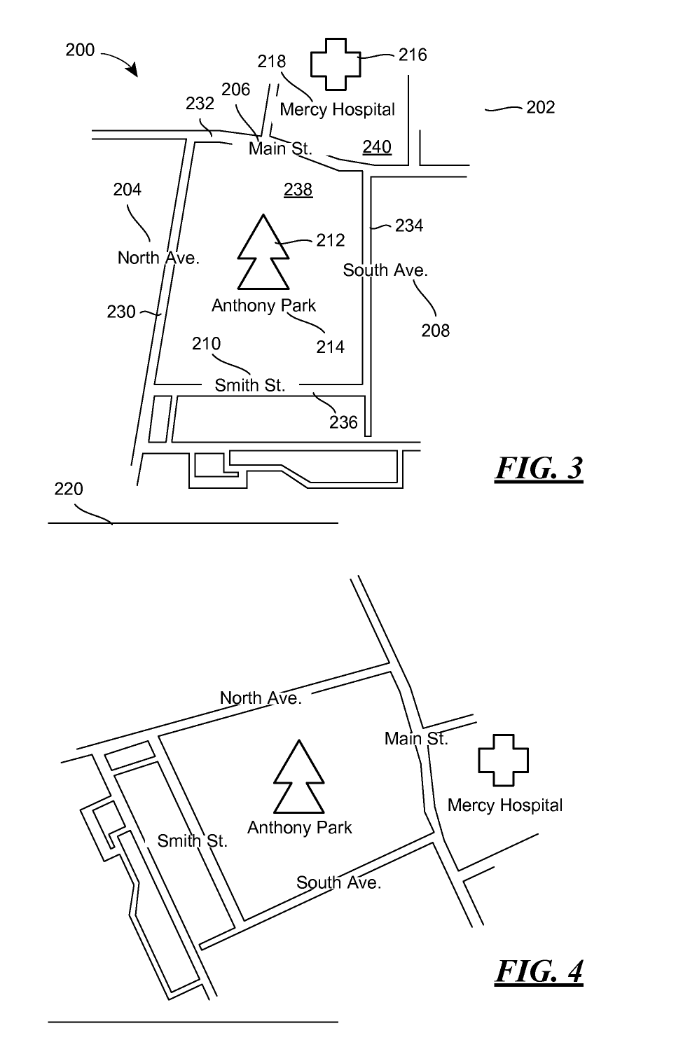

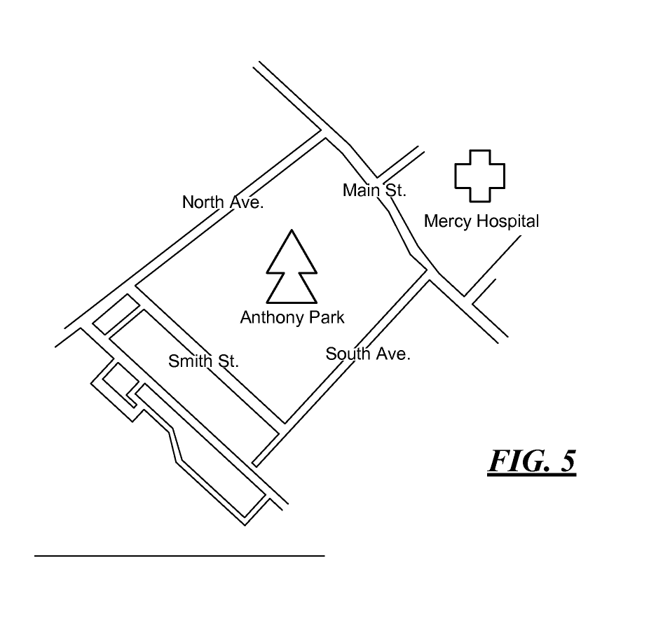

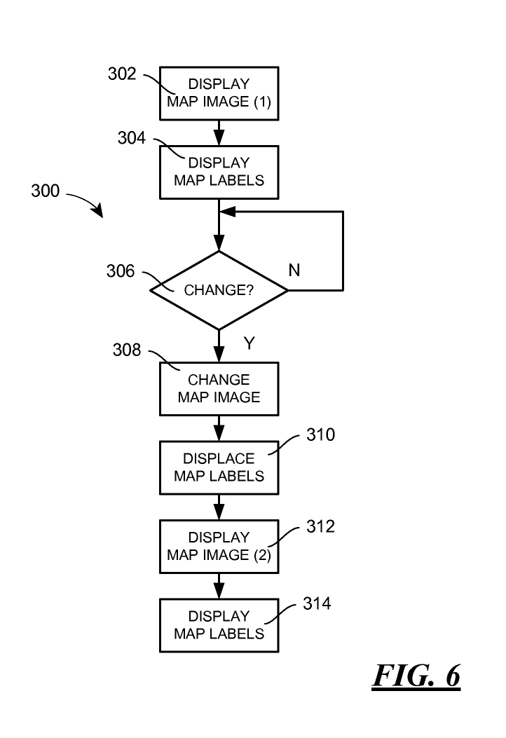

In general terms, the present disclosure relates to a method for displaying labels on a map image on a computerized mobile device such that the labels appear insensitive to changes in orientation of the underlying map image. To this end, the method may include displaying a map image in a first orientation on a display unit of a computerized mobile device and displaying at least one label in a first orientation on the display unit with the map image in the first orientation. See FIG. 2. The at least one label may be associated with at least one feature of the map image and disposed at a first location on the display unit. The method may also include changing the map image to a second orientation different from the first orientation, and displacing the at least one label from the first location to a second location to maintain the association between the at least one label and the at least one feature. The method may further include displaying the map image in the second orientation on the display unit, and displaying the at least one label in the first orientation with the map image in the second orientation, the at least on label disposed at the second location on display unit. See FIG. 3. The map image may in fact change orientations in a series of steps between the first and second orientations, while the at least one label has a single orientation. See FIGS. 4 and 5.

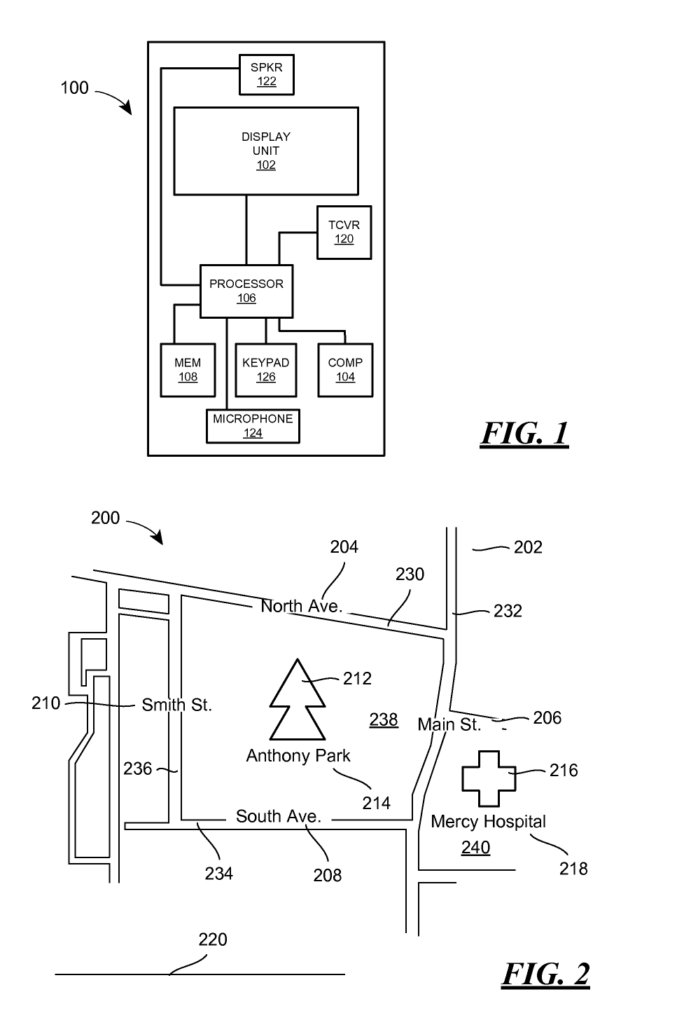

Therefore, as to one embodiment of the present disclosure, FIG. 1 illustrates a computerized mobile device 100 that includes a display unit 102, an onboard compass unit 104, and a processor 106. The processor 106 may be coupled to the display unit 102 and the onboard compass unit 104, as well as to one or more tangible non-transitory computer-readable memories 108 having computer executable instructions stored thereon, which when executed by the processor 106, may cause the one or more processors to carry out on or more actions.

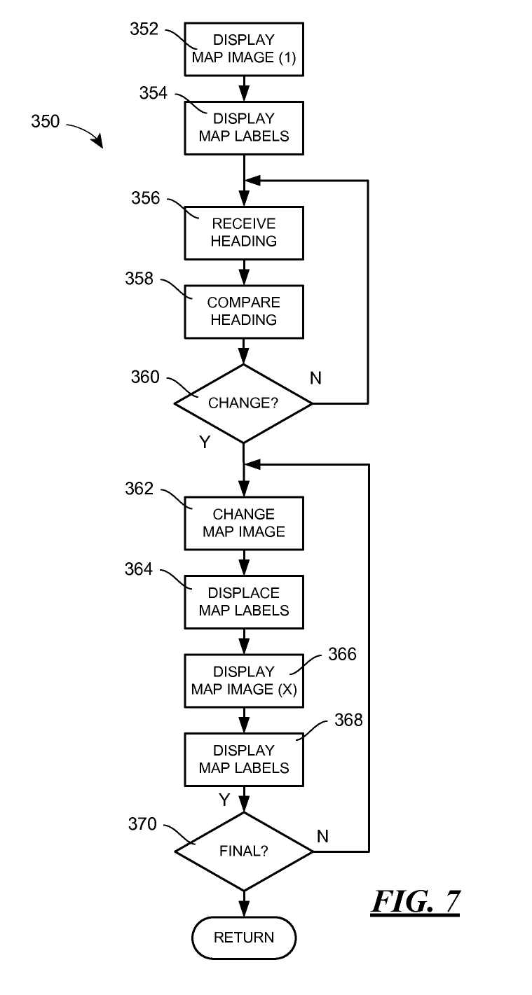

The processor 106 is programmed to carry out at least one embodiment of the method according to the present disclosure. In doing so, the processor 106 controls the display unit 102 to display, for example, an image such as is illustrated in FIG. 2 and an image such as illustrated in FIG. 3. According to certain embodiments, the processor 106 may control the display unit 102 to display a series of images between that illustrated in FIG. 2 and that illustrated in FIG. 3 (see FIGS. 4 and 5). The method carried out by the processor 106 may be as illustrated in FIG. 6 or 7.

Starting then with FIG. 2, it will be recognized that an image 200 is shown, the image 200 including a map image 202 and map labels 204, 206, 208, 210, 212, 214, 216, 218. In addition to the map image 202 and the map labels 204-218, a reference marker or edge 220 is also illustrated. The reference marker 220 may be an edge of the display unit 102 or the housing of the mobile device 100 in which the display unit 102 is mounted. As a further alternative, the reference marker may be part of the image 200, like the map image 202 and the map labels 204-218.

According to one embodiment, the map image 202 and the map labels 204-218 may be defined by map vectors and metadata, respectively. The map labels 204-218 may be associated with the map vectors that comprise the map image 202, according to such an embodiment. Moreover, while the map vectors may be redrawn or re-rendered as the map image 202 changes its orientation between that illustrated in FIG. 2 and that illustrated in FIG. 3, the metadata may not be redrawn as the map image changes its orientation, and thus may appear “fixed” or “immoveable” in the image 200 while still maintaining the association between portions or regions of the map image 202 and the labels 204-218.

As to the particular image 200 illustrated in FIGS. 2-5, the map image 202 may include representations of roadways for vehicles, such as streets, avenues, boulevards, and the like, as represented at 230, 232, 234, 236. The map image 202 may also include open areas, such as parks or parking lots, as represented at 238. The map image 202 may further include buildings, such as residential buildings, commercial buildings, and governmental buildings, such as represented at 240. These roadways, open areas, and buildings may be referred to herein as features, which term may encompass other such representations besides.

The map labels 204-218 may include information for the identification of the features 230-240 of the map image 202. Certain labels may include alphanumeric information; other labels may include symbolic information. It may be possible to define other labels that are an integrated (i.e., undivided) combination of alphanumeric and symbolic information, or that are associations of alphanumeric and symbolic information that are related within a database, for example, but the elements of which are stored and accessed separately by the processor 106.

In the particular image 200 represented in FIGS. 2-5, the map labels 204, 206, 208, 210 include the names of the various roadways represented (“North Ave.”; “Main St.”; South Ave.”; and “Smith St.”). Symbolic label 212 is used in conjunction with alphanumeric label 214 to identify the open area 238 as a park, “Anthony Park” in particular. Similarly, symbolic label 216 and alphanumeric label 218 are used to identify the building 240 as a hospital, “Mercy Hospital” in particular. Each of these labels 204-218 is associated with a particular feature 230-240 on the map image 202.

As arranged in FIG. 2, all of the alphanumeric symbols 204-210, 214, 218 are arranged so that they are parallel to the reference marker 220. If the reference marker 220 represents the proximal border (relative to the viewer) of a viewing section of the display unit 102, these symbols would all be properly aligned to be read by a viewer without the viewer having to turn his or her head to the side. In a similar fashion, the symbolic label 212 is oriented so as to appear upright relative to the reference marker 220, thereby facilitating recognition of the symbol by a viewer, assuming the reference marker 220 to represent the proximal border of a viewing section of the display unit 102.

With this by way of background, the method 300 for changing the display of the image 200 from that illustrated in FIG. 2 to that illustrated in FIG. 3, potentially intermediately through the images illustrated in FIGS. 4 and 5, may now be discussed with reference to FIGS. 6, and in greater deal with reference to FIG. 7.

As illustrated in FIG. 6, the method 300 for displaying map labels on a map image on a computerized mobile device, such as that illustrated in FIG. 1, may include displaying a map image in a first orientation on a display unit of a computerized mobile device at block 302. According to the illustrated embodiment, FIG. 2 may represent the map image 202 in a first orientation on a display unit 102 of the mobile device 100, which map image 202 may include at least one feature 230-240. The method may continue to block 304, wherein at least one label is displayed in a first orientation on the display unit with the map image in the first orientation. Again, according to the illustrated embodiment, FIG. 2 may represent at least one label 204-218 displayed in a first orientation parallel with the reference marker 220 with the map image 202 in a first orientation on the display unit 202. As illustrated, each of the labels 204-218 is associated with one of the features 230-240 and is disposed at a first location on the display unit.

The method 300 may then proceed to block 306, at which point the method 300 may wait for an indication that a change in the orientation of the map image has been requested. This indication may be in the form of an internal, automatic signal or request. For example, the processor 106 may receive a compass heading from the on-board compass 104, and may determine that the compass heading received from the on-board compass 104 differs from a compass heading used to generate the image 200 illustrated in FIG. 2. This change in compass heading may be a result of a change in the orientation of the mobile device 100, for example. Alternatively, the indication may be a consequence of the user providing activating an input or otherwise providing a signal, received by the processor 106, indicative of a wish to make the image displayed on the display unit 104 dependent upon the orientation of the device. As such, the indication may be in the form of an external signal or request. Other alternatives are also possible. Until such time as the processor 106 determines that a change is to be made, the method 300 may remain at block 306.

If the processor 106 determines at block 306 that an indication has been received to change the orientation of the image 200, or more particularly the map image 202, then the method 300 continues to block 308. At block 308, the processor 106 carries out the actions to change the orientation of the map image 202 to a second orientation different from the first orientation. For example, the processor 106 may determine the extent of the change of the orientation of the map image 202, by comparing a compass heading recently received from the compass 104 with the compass heading used to generate the image 200 illustrated in FIG. 2, which compass heading used to generate the image 200 may have itself been received from the compass 104 or may have been a predetermined orientation (e.g., the top of the display unit is north, the reference marker 220 is south) where the image had not previously been permitted to vary with the orientation of the on-board compass 104 (and thus mobile device 100). The processor 106 may then cause the map vectors that make up the map image 202 to be re-rendered according to the change in orientation of the device 100.

As noted previously, while the orientation of the labels 204-218 does not change, such that the labels may be described as “fixed,” it is also the case that the labels 204-218 are associated with features 230-240 of the map image 202. To maintain the association, it may be necessary to change the placement of the labels 204-218 on the display. Consequently, at block 210, the processor 106 may determine the displacements necessary to maintain the associations. For example, at least one of the labels 204-218 (e.g., 204) may be displaced from the first location to a second location as the map image is changed to the second orientation to maintain the association between the at least one label and the at least one feature (e.g., 230).

Once the actions of block 308, 310 have been carried out, the method 300 may continue to blocks 312 and 314, wherein the processor 106 controls the display unit to display the map image in the second orientation on the display unit, and display the at least one label in the first orientation with the map image in the second orientation, the at least one label disposed at the second location on the display unit. For example, the processor 106 may control the display unit 102 to display the map image 202 as illustrated in FIG. 3, which map image 202 is orientated such that the orientation of the map image 202 has changed 90 degrees relative to that illustrated in FIG. 2 (i.e., the map image 202 of FIG. 3 is orthogonal to that illustrated in FIG. 2). Moreover, the processor 106 may control the display unit 102 to display the map labels 204-218 as illustrated in FIG. 3, which map labels 204-218 are oriented such that their orientation is substantially the same as that illustrated in FIG. 2 but with their placement on the display unit altered to maintain the association between the labels 204-218 with the features 230-240.

In fact, to extent that the map image 202 in FIG. 2 comprises a street a portion of which is parallel to the reference edge 220 in the first orientation (e.g., “South Ave” 234), the street may be orthogonal to the reference edge 220 in the second orientation illustrated in FIG. 3. On the other hand, a label, such as “South Ave.” may be displayed parallel to the reference edge 220 in both the image 200 of FIG. 2 and that of FIG. 3. In both instances, the label may be located at the midpoint of the portion of the street to maintain the association between the label and the feature.

A more detailed version of the method 350 for changing the display of the image 200 from that illustrated in FIG. 2 to that illustrated in FIG. 3 is illustrated in FIG. 7. This version of the method 350 explicitly includes optional actions or intermediate actions included within the more broadly described method 300 of FIG. 6.

As illustrated in FIG. 7, the method 350 for displaying map labels on a map image on a computerized mobile device, such as that illustrated in FIG. 1, may include displaying a map image in a first orientation on a display unit of a computerized mobile device at block 352. According to the illustrated embodiment, FIG. 2 may represent the map image 202 in a first orientation on a display unit 102 of the mobile device 100, and may include the features 230-240 previously mentioned. The method may continue to block 354, wherein at least one label is displayed in a first orientation on the display unit with the map image in the first orientation on the display unit. Again, according to the illustrated embodiment, FIG. 2 may represent at least one label (in this case, a plurality of labels) 204-218 displayed in a first orientation (parallel with the reference marker 220) with the map image 202 in a first orientation on the display unit 202, the labels 204-218 associated with one of the features 230-240 and disposed at a first location on the display unit.

The method 300 may then proceed to block 356, at which point the processor 106 may receive a heading from the compass 104. The processor 106 may then compare the heading received from the compass 104 with a previous heading, which may have been stored by the processor 106 in the memory 108, at block 358. In comparing the heading received from the compass 104 with a previous heading, which may have been stored in the memory 108, the processor 106 may detect motion of the mobile device 100 about an axis from a first orientation to a second orientation (i.e., from along a first heading to along a second heading). It will be recognized that the actions of blocks 356, 358 are merely one embodiment for detecting motion of the mobile device 100 using the processor 106, and that other embodiments may be substituted for the actions of blocks 356, 358.

A determination is made at block 360 as to whether the heading received at block 356 and compared with the previous heading at block 358 reflects a change in the orientation of the mobile device 100. It will be recognized that the determination as to whether a change has occurred at block 360 may occur only when the change in heading, as determined by the comparison conducted at block 358, exceeds a predetermined range or threshold. For example, if the comparison at block 358 suggests that the heading has changed by no more than 5 or 10 degrees, then the processor 106 may determine that no change in the image 200 is required. However, if the processor 106 compares the heading received at block 358 and the heading has changed more than 10 degrees, then the processor may determine at block 360 that the method should proceed to block 362. Otherwise, the method 350 may return and repeat blocks 356, 358 until a determination is made at block 360 that a sufficient change in the heading of the mobile device 100 has occurred so as to prompt a change the image displayed on the display unit 104.

If the processor 106 determines at block 360 that the orientation of the mobile device 100 has changed sufficiently so as to prompt a change in the orientation of the image 200, or more particularly the map image 202, then the method 300 continues to blocks 362, 364, 366, 368. In particular, the processor 106 carries out the actions to change the orientation of the map image 202 to a second orientation different from the first orientation at block 362, and to displace the at least one label from the first location to a second location as the map image is changed to the second orientation to maintain the association between the at least one label and the at least one feature at block 364. According to the embodiment of the method 350 illustrated in FIG. 7, the processor 106 may determine the extent of the change of the orientation of the map image 202 and of the displacement of the labels 204-218 by comparing the compass heading recently received from the compass 104 at block 356 with the compass heading used to generate the image 200 illustrated in FIG. 2, which compass heading may have been stored by the processor 106 in the memory 108. The processor 106 may then establish a series of orientation changes for the map image 202 and displacements for the labels 204-218 to process through, which series of orientation changes and displacements will begin with the map image 202 as presently displayed and will end with the map image 202 as displayed according to the change in heading determined by the comparison at block 358. For example, the processor may determine that the map image will pass through a series of orientation changes wherein each orientation change reflects a difference of 30 degrees relative to the previously displayed image. The processor 106 may then cause the map vectors that make up the map image 202 to be redrawn to reflect the first change in orientation of the device 100 (e.g., the map image 202 as illustrated in FIG. 4 when compared with that illustrated in FIG. 2).

Once the map image has been changed and the labels 204-218 displaced at blocks 362, 364, the method 350 may continue to blocks 366 and 368, wherein the processor 106 controls the display unit to display the map image according to the first orientation change on the display unit, and to display the at least one label associated with the map image in substantially the same orientation as it was previously but displaced according to the orientation changes for the map image 202. For example, the processor 106 may control the display unit 102 to display the map image 202 as illustrated in FIG. 4, which map image 202 is orientated such that the orientation of the map image 202 has changed 30 degrees relative to that illustrated in FIG. 2 (i.e., the map image 202 of FIG. 3 is angled 30 degrees to that illustrated in FIG. 2). Moreover, the processor 106 may control the display unit 102 to display the map labels 204-218 as illustrated in FIG. 4, which map labels 204-218 are oriented such that their orientation is substantially the same as that illustrated in FIG. 2 but displaced as necessary to maintain the association between labels 204-218 and features 230-240.

The method 350 may then continue to block 370, wherein the processor 106 makes a determination as to whether the map image 202 has been displayed in its final form (e.g., the map image 202 reflects the compass heading received at block 356). If the processor 106 determines that the orientation of the map image 202 needs to be further changed (i.e., the map image is not in its final form), then the method 350 returns and repeats blocks 362, 364, 366, 368 until the determination is made at block 370 that the map image 202 has been displayed in its final form. When the determination is made at block 370 that the map image has been displayed in its final form, the method 350 may return to block 356 for example. Alternatively, the image 200 as it is presently displayed may now be defined as the map image in its first orientation, and the method 350 may repeat relative to this new definition of the first orientation of the map image.

In relation to other alternative embodiments, the device 100 may also include and the processor may also be coupled to other equipment according to the desired operational functionality of the device 100.

For example, the device 100 illustrated in FIG. 1 may be a configured to be a mobile telephone or smart phone. In such a case, the device 100 may include a radio frequency (RF) transceiver 120 to communicate with a mobile communication system over an RF communication link. The device 100 may also include a speaker 122 and a microphone 124 to facilitate use of the device 100 as a telephone. The device 100 may also include a keypad or keyboard 126 to permit alphanumeric communication, or the display unit 102 may alternatively be configured as a touch screen. All of these additional devices 120, 122, 124, 126 may be coupled to the processor 106.

Alternatively, the device 100 may be configured to be a mobile computing device without telephonic capability. According to such an embodiment, the device 100 may still include an RF transceiver 120, but the transceiver may be configured to facilitate communication with wireless local area computer network, for example a wireless local area network (WLAN) based on the IEEE 802.11 protocol, sometimes referred to as a Wi-Fi network. The device may also include the speaker 122 as well as the keypad or keyboard 126 to facilitate communication over the wireless computer network. However, in addition to featuring a different transceiver, the device may also lack the microphone 124, and may instead include a camera, for example.

Moreover, while orientation of the device 100 has been discussed relative to an on-board compass 104, it will be recognized that this is simply one embodiment of a mechanism for determining the orientation of the device. In the alternative, the orientation of the mobile device 100 may be determined by referencing an external coordinate determining system, such as the Global Positioning System (GPS). For example, the mobile device 100 may include a coordinate receiver that is in communication with such an external coordinate determining system, and the processor 106 may use two or more coordinates received from such a system to determine a heading for the mobile device 100, which heading may be used interchangeably with the compass heading received from the on-board compass 104 as discussed above.

Further, it will be recognized that although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

In addition, to the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph. In addition, it should be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims).

1. A method for displaying labels on a map image on a computerized mobile device, comprising:
displaying a map image in a first orientation relative to a reference marker on a display unit of a computerized mobile device, the map image comprising a plurality of features wherein at least some of the features are associated with respective labels and comprising a plurality of map vectors, wherein the reference marker is one of: an edge of the display unit, a housing of the computerized mobile device, or a portion of the map image;
displaying all of the labels present in the map image in the first orientation relative to the reference marker on the display unit with the map image in the first orientation, all of the labels disposed at respective first locations on the display unit and comprising metadata;
changing the map image to a second orientation relative to the reference marker different from the first orientation using a processor of the computerized mobile device by redrawing the map vectors as the map image changes from the first orientation to the second orientation;
displacing all of the label from the respective first locations to respective second locations as the map image is changed to the second orientation to maintain the association between all of the label and the associated at least some of the of features using the processor without applying an additional calculation to the metadata included in any of the labels;
displaying the map image in the second orientation on the display unit; and
displaying all of the labels in the first orientation relative to the reference marker with the map image in the second orientation relative to the reference marker, all of the labels disposed at the respective second locations on the display unit.

2. The method according to claim 1, further comprising:
displaying the map image in a series of orientations on the display unit between the first orientation and the second orientation as the map image is changed from the first orientation to the second orientation; and
displaying all of the labels in the first orientation while the map image is displayed in each of the series of orientations between the first orientation and the second orientation as the map image is changed from the first orientation to the second orientation, all of the labels disposed at one of a plurality of respective locations on the display unit to maintain the associations between all of the labels and the at least some of the features.

3. (canceled)

4. The method according to claim 1, wherein at least one of the labels comprises alphanumeric information.

5. The method according to claim 1, wherein the second orientation of the map image is orthogonal to the first orientation of the map image.

6. The method according to claim 1, wherein:
the reference marker is the edge of the display unit;
the map image comprises a street a portion of which is parallel to the reference marker in the first orientation, and is orthogonal to the reference marker in the second orientation; and
at least one of the labels comprises a street name associated with the street, the at least one label being displayed parallel to the reference marker in the first orientation.

7. The method according to claim 1, further comprising:
detecting motion of the computerized mobile device about an axis from a first orientation to a second orientation; and
changing the map image from the first orientation to the second orientation upon detecting the motion of the computerized media device about the axis from the first orientation to the second orientation.

8. The method according to claim 7, wherein second orientation of the computerized mobile device is orthogonal to the first orientation of the computerized mobile device.

9. The method according to claim 7, wherein detecting motion of the computerized mobile device comprises automatically detecting a change in orientation of an onboard sensor.

10. The method according to claim 9, wherein the onboard sensor is a compass.

11. A computerized mobile device comprising:
a display unit;
a processor coupled to the display unit, the processor programmed:
to control the display unit to display a map image in a first orientation relative to a reference marker on a display unit of a computerized mobile device, the map image comprising a plurality of features wherein at least some of the features are associated with respective labels and comprising a plurality of map vectors, wherein the reference marker is one of: an edge of the display unit, a housing of the computerized mobile device, or a portion of the map image;
to control the display unit to display all of the labels present in the map image in the first orientation relative to the reference marker on the display unit with the map image in the first orientation, all of the labels disposed at respective first locations on the display unit and comprising metadata;
to change the map image to a second orientation relative to the reference marker different from the first orientation by redrawing the map vectors as the map image changes from the first orientation to the second orientation;
to displace all of the labels from the respective first locations to respective second locations as the map image is changed to the second orientation to maintain the association between all of the labels and the associated at least some of the features without applying an additional calculation to the metadata included in any of the labels;
to control the display unit to display the map image in the second orientation on the display unit; and
to control the display unit to display all of the labels in the first orientation relative to the reference marker with the map image in the second orientation relative to the reference marker, all of the labels disposed at the respective second locations on the display unit.

12. The computerized mobile device according to claim 11, the processor further programmed to control the display unit:
to display the map image in a series of orientations on the display unit between the first orientation and the second orientation as the map image is changed from the first orientation to the second orientation; and
to display all of the labels in the first orientation while the map image is displayed in each of the series of orientations between the first orientation and the second orientation as the map image is changed from the first orientation to the second orientation, all of the labels disposed at one of a plurality of respective locations on the display unit to maintain the associations between all of the labels and the at least some of the features.

13. (canceled)

14. The computerized mobile device according to claim 11, wherein at least one of the labels comprises alphanumeric information.

15. The computerized mobile device according to claim 11, wherein the second orientation of the map image is orthogonal to the first orientation of the map image.

16. The computerized mobile device according to claim 11, wherein:
the reference marker is the edge of the display unit;
the map image comprises a street a portion of which is parallel to the reference marker in the first orientation, and is orthogonal to the reference marker in the second orientation; and
at least one of the labels comprises a street name associated with the street, the at least one label being displayed parallel to the reference marker in the first orientation.

17. The computerized mobile device according to claim 11, the processor further programmed to:
to detect motion of the computerized mobile device about an axis from a first orientation to a second orientation; and
to change the map image to a second orientation upon detecting the motion of the computerized media device about the axis from the first orientation to the second orientation.

18. The computerized mobile device according to claim 17, wherein second orientation of the computerized mobile device is orthogonal to the first orientation of the computerized mobile device.

19. The computerized mobile device according to claim 17, wherein the detection motion of the computerized mobile device comprises automatic detection of a change in orientation of an onboard sensor.

20. The computerized mobile device according to claim 19, wherein the onboard sensor is a compass.

21. A tangible non-transitory computer-readable medium having computer executable instructions stored thereon that, when executed by one or more processors of a computerized mobile device, cause the one or more processors to:
control a display unit to display a map image in a first orientation relative to a reference marker on a display unit of a computerized mobile device, the map image comprising a plurality of features wherein at least some of the features are associated with respective labels and comprising a plurality of map vectors, wherein the reference marker is one of: an edge of the display unit, a housing of the computerized mobile device, or a portion of the map image;
control a display unit to display all of the labels present in the map image in the first orientation relative to the reference marker on the display unit with the map image in the first orientation, all of the labels disposed at respective first locations on the display unit and comprising metadata;
change the map image to a second orientation relative to the reference marker different from the first orientation by redrawing the map vectors as the map image changes from the first orientation to the second orientation;
displace all of the labels from the respective first locations to respective second locations as the map image is changed to the second orientation to maintain the association between all of the labels and the associated at least some of the of features without applying an additional calculation to the metadata included in any of the labels;
control a display unit to display the map image in the second orientation on the display unit; and
control a display unit to display all of the labels in the first orientation relative to the reference marker with the map image in the second orientation relative to the reference marker, all of the labels disposed at the respective second locations on the display unit.

22. The tangible non-transitory computer-readable medium according to claim 21, having computer executable instructions stored thereon that, when executed by one or more processors, cause the one or more processors to:
control a display unit to display the map image in a series of orientations on the display unit between the first orientation and the second orientation as the map image is changed from the first orientation to the second orientation; and
control a display unit to display all of the labels in the first orientation while the map image is displayed in each of the series of orientations between the first orientation and the second orientation as the map image is changed from the first orientation to the second orientation, all of the labels disposed at one of a plurality of respective locations on the display unit to maintain the associations between all of the labels and the at least some of the features.

23. (canceled)

24. The tangible non-transitory computer-readable medium according to claim 21, wherein at least one of the labels comprises alphanumeric information.

25. The tangible non-transitory computer-readable medium according to claim 21, wherein the second orientation of the map image is orthogonal to the first orientation of the map image.

26. The tangible non-transitory computer-readable medium according to claim 21, wherein:
the reference marker is the edge of the display unit;
the map image comprises a street a portion of which is parallel to the reference marker in the first orientation, and is orthogonal to the reference marker in the second orientation; and
at least one of the labels comprises a street name associated with the street, the at least one label being displayed parallel to the reference marker in the first orientation.

27. The tangible non-transitory computer-readable medium according to claim 21, having computer executable instructions stored thereon that, when executed by one or more processors, cause the one or more processors to:
detect motion of the computerized mobile device about an axis from a first orientation to a second orientation; and
change the map image to a second orientation upon detecting the motion of the computerized media device about the axis from the first orientation to the second orientation.

28. The tangible non-transitory computer-readable medium according to claim 27, wherein second orientation of the computerized mobile device is orthogonal to the first orientation of the computerized mobile device.

29. The tangible non-transitory computer-readable medium according to claim 27, wherein detecting motion of the computerized mobile device comprises automatically detecting a change in orientation of an onboard sensor.

30. The tangible non-transitory computer-readable medium according to claim 29, wherein the onboard sensor is a compass.
